(19) United States
(12) Patent Application Publication
(10) Pub. No.: US 2021/0339491 A1
(43) Pub. Date: Nov. 4, 2021

(54) MANUFACTURING METHOD OF HIGH-PRESSURE TANK

(71) Applicant: TOYOTA JIDOSHA KABUSHIKI KAISHA, Toyota-shi (JP)

(72) Inventor: Naoki UEDA, Nagoya-shi (JP)

(73) Assignee: TOYOTA JIDOSHA KABUSHIKI KAISHA, Toyota-shi (JP)

(21) Appl. No.: 17/214,227

(22) Filed: Mar. 26, 2021

(30) Foreign Application Priority Data
May 1, 2020 (JP) 2020-081508

(51) Int. Cl. B29D 22/00; B29C 53/56

(52) U.S. Cl. CPC B29D 22/003; B29K 2105/08; B29C 53/56

(57) ABSTRACT

A manufacturing method of a high-pressure tank includes a step of forming a first reinforcing body involving cooling a first resin-impregnated fiber bundle fed from a fiber bundle feeding device and having a first temperature to a second temperature lower than the first temperature and winding the cooled first resin-impregnated fiber bundle around a mandrel or a liner. The first resin-impregnated fiber bundle includes fine particles that contain an acrylic resin or a butadiene resin as a main component. A high-pressure tank including the liner that houses gas and the first reinforcing body that covers an outer surface of the liner is manufactured.

### CROSS-REFERENCE TO RELATED APPLICATION

This application claims priority to Japanese Patent Application No. 2020-081508 filed on May 1, 2020, incorporated herein by reference in its entirety.

### BACKGROUND

### 1. Technical Field

The disclosure relates to a manufacturing method of a high-pressure tank.

### 2. Description of Related Art

As a high-pressure tank used to store and supply hydrogen etc., a tank including a tank main body and a cap mounted at an open end, in a longitudinal direction, of the tank main body has been hitherto known. The tank main body includes, for example, a liner that hermetically holds a hydrogen gas, and a fiber-reinforced resin layer formed by fiber bundles that are made of a fiber-reinforced resin and wound around an outer surface of the liner for reinforcement.

Examples of known manufacturing methods of a high-pressure tank include one in which resin-impregnated fibers are wound around an outer surface of a liner by a filament winding method (hereinafter also referred to simply as the “FW method”) and cured to form a resin-impregnated fiber layer (e.g., see Japanese Unexamined Patent Application Publication No. 2011-179638 (JP 2011-179638 A)).

While being wound around an outer surface of a liner, resin-impregnated fibers may sideslip and be wound around the liner along a path different from a set path, which can result in variation in the strength of the high-pressure tank.

JP 2011-179638 A describes a manufacturing method of a high-pressure tank in which a resin-impregnated fiber layer is provided on an outer surface of a hollow metal liner having dome-shaped ends. In the manufacturing method of JP 2011-179638 A, a step of winding the resin-impregnated fibers around the outer surface of the metal liner involves cooling the resin-impregnated fibers at the domed parts of the metal liner by cooling devices that are disposed facing the domed parts to thereby reduce the likelihood of sideslipping of the resin-impregnated fibers at the domed parts.

### SUMMARY

Thorough studies conducted by the present inventor have found that simply cooling resin-impregnated fibers at domed parts cannot sufficiently reduce the likelihood of sideslipping of the resin-impregnated fibers and may fail to prevent sideslipping of the resin-impregnated fibers. Therefore, the disclosure aims to provide a manufacturing method of a high-pressure tank in which the likelihood of sideslipping of resin-impregnated fibers is further reduced.

According to a first aspect of the disclosure, a manufacturing method of a high-pressure tank including a liner that houses gas and a first reinforcing body that covers an outer surface of the liner is provided.

The manufacturing method includes a step of forming the first reinforcing body involving cooling a first resin-impregnated fiber bundle fed from a fiber bundle feeding device and having a first temperature to a second temperature lower than the first temperature and winding the cooled first resin-impregnated fiber bundle around a mandrel or the liner.

The first resin-impregnated fiber bundle includes fine particles that contain an acrylic resin or a butadiene resin as a main component.

A manufacturing method of a high-pressure tank in which the likelihood of sideslipping of resin-impregnated fibers is further reduced is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view of a high-pressure tank manufactured by a manufacturing method of a first embodiment;

FIG. 2 is a schematic partial sectional view of the high-pressure tank manufactured by the manufacturing method of the first embodiment;

FIG. 3 is a flowchart showing the manufacturing method of the first embodiment;

FIG. 4 is a schematic partial sectional view illustrating a domed member formation step;

FIG. 5 is a schematic sectional view illustrating the domed member formation step;

FIG. 6 is a schematic perspective view illustrating a tubular member formation step;

FIG. 7 is a schematic perspective view illustrating the tubular member formation step, and is a view showing an end region, in an axial direction, of the tubular member and a part near the end region;

FIG. 8 is a schematic perspective view illustrating a joining step;

FIG. 9 is a schematic sectional view illustrating the joining step;

FIG. 10 is a schematic perspective view illustrating a second reinforcing body formation step;

FIG. 11 is a schematic perspective view illustrating the second reinforcing body formation step;

FIG. 12 is a schematic sectional view illustrating a first modified example;

FIG. 13 is a schematic perspective view illustrating a second modified example;

FIG. 14 is a schematic sectional view illustrating a liner formation step;

FIG. 15 is a schematic perspective view illustrating a third modified example;

FIG. 16 is a schematic perspective view illustrating a fourth modified example;

FIG. 17 is a schematic sectional view illustrating a fifth modified example;

FIG. 18 is a schematic sectional view illustrating a sixth modified example;

FIG. 19 is a schematic sectional view of a high-pressure tank manufactured by a manufacturing method of a second embodiment;

FIG. 20 is a flowchart showing the manufacturing method of the second embodiment;

FIG. 21 is a schematic side view illustrating a reinforcing body formation step; and

FIG. 22 is a graph showing a measurement result of tack strengths of Resin compositions 1 to 3.

### DETAILED DESCRIPTION OF EMBODIMENTS

Embodiments will be described below. In the embodiments, equivalent elements will be denoted by the same reference signs and a detailed description thereof may be omitted.

### (1) First Embodiment

First, the configuration of a high-pressure tank 10 manufactured by a manufacturing method of a first embodiment will be described. In the following, an example of the high-pressure tank 10 that is installed in a fuel-cell vehicle and filled with a high-pressure hydrogen gas will be described, but the manufacturing method of the first embodiment is also applicable to the manufacturing of the high-pressure tank 10 that is used for other purposes. The gas filling the high-pressure tank 10 is not limited to a high-pressure hydrogen gas. The high-pressure tank 10 may be filled with various fuel gasses, for example, a compressed gas such as a compressed natural gas (CNG), or a liquid gas such as a liquefied natural gas (LNG) or liquefied petroleum gas (LPG). Further, the high-pressure tank 10 may be installed in, other than a fuel-cell vehicle, a moving body such as a ship or an airplane, or a stationary facility such as a house or a building.

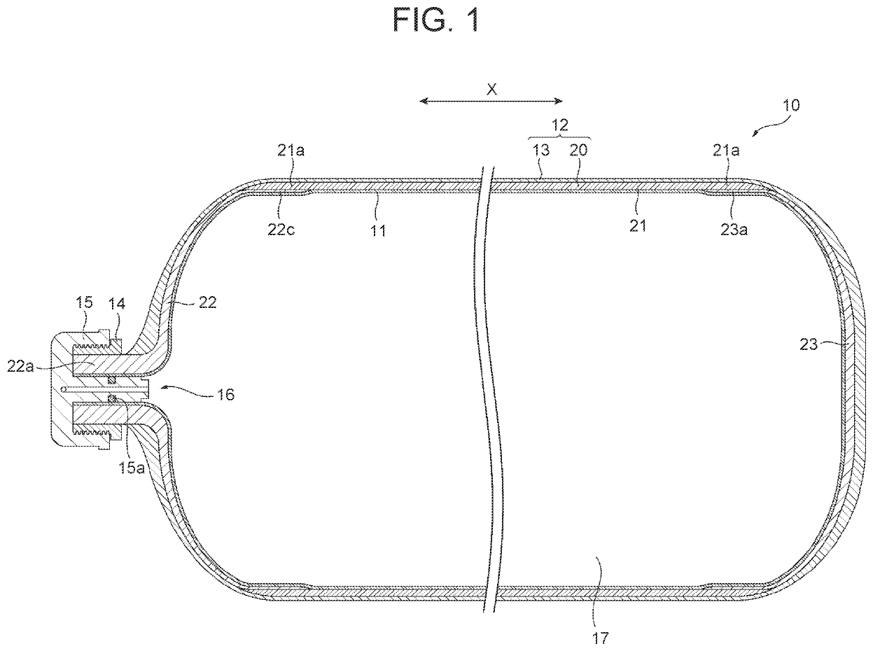

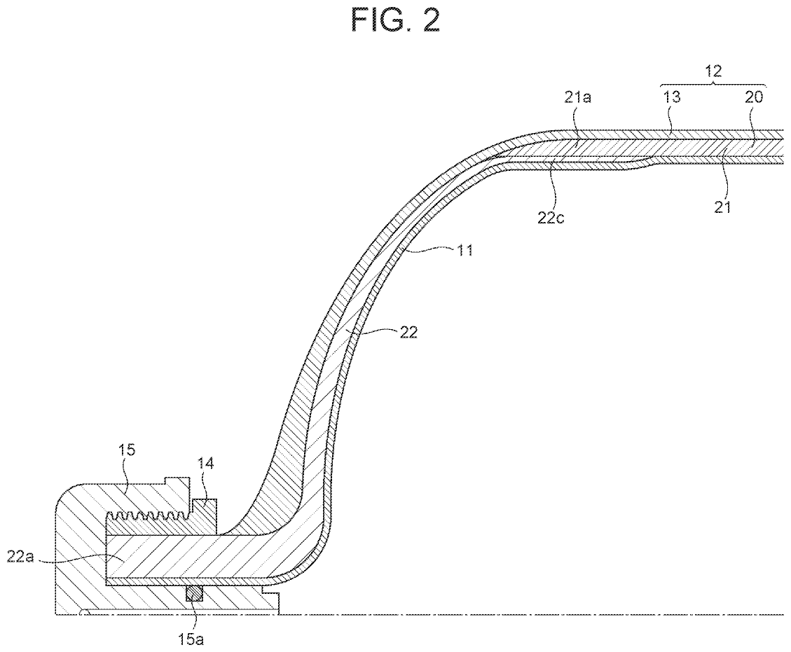

The high-pressure tank 10 shown in FIG. 1 and FIG. 2 has a substantially cylindrical shape with both ends rounded into a dome shape. The high-pressure tank 10 includes a liner 11 having gas barrier properties, a first reinforcing body 20 that covers an outer surface of the liner 11, and a second reinforcing body 13 that covers an outer surface of the first reinforcing body 20. The high-pressure tank 10 has an opening 16 at one end. A cap 14 is mounted over the opening 16. At the other end of the high-pressure tank 10, no opening is formed and no cap is provided.

The liner 11 is formed along an inner surface of the first reinforcing body 20. The liner 11 has a substantially cylindrical shape. Specifically, the liner 11 has a cylindrical part having a cylindrical shape, and domed parts having a dome shape (e.g., a semispherical shape, substantially semielliptical shape, paraboloidal surface shape, or bowl shape) and disposed at both ends of the cylindrical part. The liner 11 defines a housing space 17 that is filled with a high-pressure hydrogen gas. The liner 11 is made of a resin. The resin composing the liner 11 may have high gas barrier properties, so that the gas filling the liner 11 (here, a hydrogen gas) is held inside the housing space 17. Examples of such a resin include thermoplastic resins such as polyamide, polyethylene, ethylene vinyl alcohol copolymer resin (EVOH), and polyester, and a thermosetting resin such as epoxy.

The cap 14 is formed by processing a metal material, such as aluminum or an aluminum alloy, into a predetermined shape. A valve 15 for filling the housing space 17 with a hydrogen gas and discharging the hydrogen gas from the housing space 17 is mounted on the cap 14. The valve 15 is provided with a seal member 15a that comes into contact with the inner surface of the liner 11 at a protruding part 22a of a first domed member 22, to be described later, and seals the housing space 17 of the high-pressure tank 10.

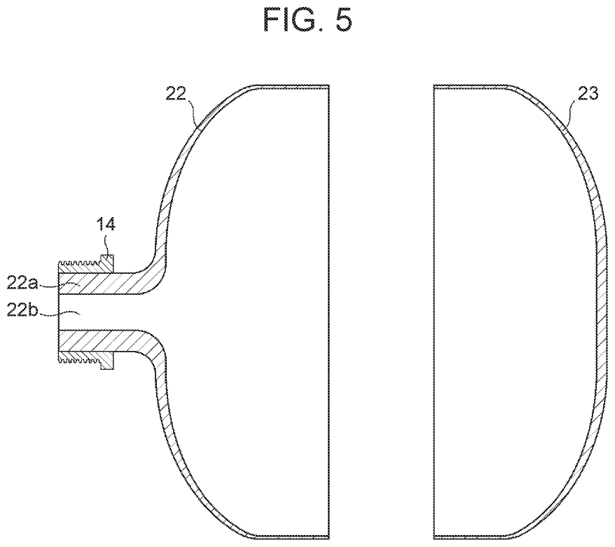

The first reinforcing body 20 reinforces the liner 11 by covering the outer surface of the liner 11, and thereby enhances the mechanical strength, such as the rigidity and the pressure resistance, of the high-pressure tank 10. The first reinforcing body 20 includes a tubular member 21 having a cylindrical shape, and two domed members (i.e., the first domed member 22 and a second domed member 23) connected at both ends of the tubular member 21, and the tubular member 21, the first domed member 22, and the second domed member 23 are integrated. The first domed member 22 and the second domed member 23 have a dome shape, for example, a semispherical shape, substantially semielliptical shape, paraboloidal surface shape, or bowl shape. The first domed member 22 has a cylindrical part (protruding part) 22a that protrudes from the dome-shaped part. The protruding part 22a defines a through-hole 22b (see FIG. 5). Thus, the opening 16 of the high-pressure tank 10 is defined.

The first reinforcing body 20 is composed of a fiber-reinforced resin including a resin, fibers, and fine particles that contain an acrylic resin or a butadiene resin as a main component. That is, each of the tubular member 21, the first domed member 22, and the second domed member 23 is composed of a fiber-reinforced resin including a resin, fibers, and fine particles that contain an acrylic resin or a butadiene resin as a main component. Here, the “fibers” are continuous fibers. In the tubular member 21, the fibers extend in a circumferential direction of the tubular member 21 and are wound at least once around the tubular member 21 in the circumferential direction. The tubular member 21 is composed of an appropriate amount of fiber-reinforced resin such that the tubular member 21 can withstand a hoop stress caused by the pressure of the gas filling the liner 11. In the first domed member 22 and the second domed member 23, the fibers are disposed so as to extend in various directions intersecting the circumferential direction of the tubular member 21 and overlap one another. The first domed member 22 and the second domed member 23 are composed of an appropriate amount of fiber-reinforced resin such that the first domed member 22 and the second domed member 23 can withstand a stress caused by the pressure of the gas filling the liner 11.

The fibers of the tubular member 21 and the fibers of the first domed member 22 and the second domed member 23 are not continuous with each other. As will be described later, this is because the tubular member 21 and the first and second domed members 22, 23 are separately formed and the first domed member 22 and the second domed member 23 are joined at both ends of the tubular member 21.

The second reinforcing body 13 is formed so as to cover the outer surface of the first reinforcing body 20. The second reinforcing body 13 is composed of a fiber-reinforced resin containing a resin and fibers. In the second reinforcing body 13, the fibers are laid over the first domed member 22 and the second domed member 23 so as to extend parallel to or at an angle of 45 degrees or smaller relatively to an axial direction X of the high-pressure tank 10 (i.e., an axial direction of the tubular member 21). The fibers prevent the first domed member 22 and the second domed member 23 from moving in the axial direction X and coming off the tubular member 21 under the pressure of the gas filling the liner 11.

Hereinafter, the first reinforcing body 20 and the second reinforcing body 13 will be collectively referred to as a “fiber-reinforced resin member 12” as necessary.

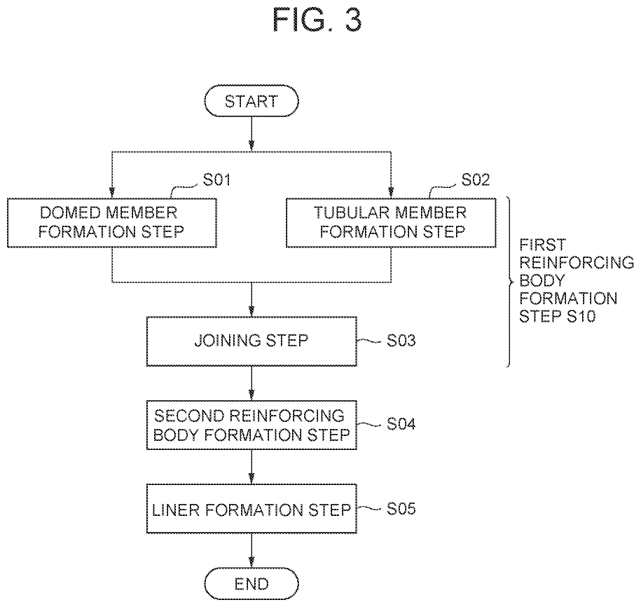

Next, the manufacturing method of the high-pressure tank 10 according to the first embodiment will be described. As shown in FIG. 3, the manufacturing method of the high-pressure tank 10 includes a domed member formation step S01, a tubular member formation step S02, a joining step S03, a second reinforcing body formation step S04, and a liner formation step S05. Since the domed member formation step S01 and the tubular member formation step S02 are independent steps, these steps may be performed concurrently or either of the steps may be performed first. Since the first reinforcing body 20 is formed by the domed member formation step S01, the tubular member formation step S02, and the joining step S03, these steps will also be collectively referred to as a first reinforcing body formation step S10.

(i) Domed Member Formation Step S01

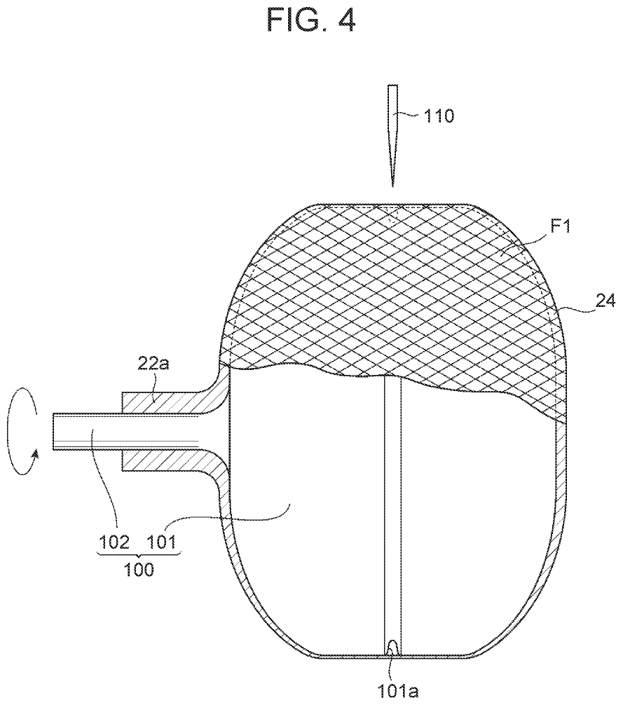

A mandrel 100 for forming the first domed member 22 and the second domed member 23 is prepared. As shown in FIG. 4, the mandrel 100 has a main body 101 and a shaft 102 that has a cylindrical shape and extends from one end of the main body 101. The shaft 102 is connected to a rotating mechanism (not shown) such that the mandrel 100 can rotate around the shaft 102 as an axis. The main body 101 includes two dome-shaped parts, and these dome-shaped parts face each other so as to be convex toward an outer side. The main body 101 has a circular shape as seen from an axial direction of the shaft 102. A groove 101a that extends along the entire circumference of the mandrel 100 in a rotation direction is formed in an outer surface of the main body 101. The groove 101a is located at the center of the main body 101 in the axial direction of the shaft 102. While not particularly limited, the material of the mandrel 100 may be metal to keep the mandrel 100 from deforming while a first resin-impregnated fiber bundle F1 is wound.

The first resin-impregnated fiber bundle F1 is prepared. The first resin-impregnated fiber bundle F1 includes a resin, fibers, and fine particles containing an acrylic resin or a butadiene resin as a main component. The first resin-impregnated fiber bundle F1 can be obtained by impregnating a bundle of fibers with a mixture of fine particles and a resin (a resin composition).

While the resin is not particularly limited, for example, a thermosetting resin can be used. As the thermosetting resin, a thermosetting resin such as a phenol resin, melamine resin, urea resin, or epoxy resin can be preferably used, and particularly an epoxy resin can be preferably used from the perspective of the mechanical strength etc. Generally, an epoxy resin can be obtained by mixing a prepolymer that is a copolymer of bisphenol A and epichlorohydrin or the like, and a curing agent such as polyamine, and then thermally curing the mixture. An epoxy resin has fluidity in an uncured state and forms a strong crosslinked structure when thermally cured.

As the fibers, glass fibers, aramid fibers, boron fibers, carbon fibers, or the like can be used, and particularly carbon fibers can be preferably used from the viewpoint of the light weight, the mechanical strength, etc.

The fine particles contain an acrylic resin or a butadiene resin as a main component. Or the fine particles are made of an acrylic resin or a butadiene resin. The size of the fine particles may be appropriately selected according to the diameter of the fibers such that the first reinforcing body 20 formed by the first resin-impregnated fiber bundle F1 has sufficient strength. For example, when the fibers included in the first resin-impregnated fiber bundle F1 are carbon fibers with a diameter of about 5 μm, the fine particles may have a particle diameter of 1 μm or smaller.

As shown in FIG. 4, the first resin-impregnated fiber bundle F1 is wound around the mandrel 100 by the FW method. Specifically, first, the first resin-impregnated fiber bundle F1 having a first temperature is fed from a fiber bundle feeding device (not shown) toward the mandrel 100. Then, the first resin-impregnated fiber bundle F1 is cooled to a second temperature lower than the first temperature. While the mandrel 100 is rotated, the cooled first resin-impregnated fiber bundle F1 is wound around the outer surface of the mandrel 100 so as to cover the outer surface of the mandrel 100. Thus, a winding 24 formed by the first resin-impregnated fiber bundle F1 is obtained. The first resin-impregnated fiber bundle F1 is wound also around an outer surface of the shaft 102. As a result, the winding 24 has the protruding part 22a. The first resin-impregnated fiber bundle F1 may be wound at an angle of, for example, 40 degrees relatively to the axial direction of the shaft 102.

The fiber bundle feeding device may be installed in a first room that is kept at the first temperature, while the mandrel 100 may be installed in a second room that is kept at the second temperature. Thus, the first resin-impregnated fiber bundle F1 can be wound around the mandrel 100 after being cooled from the first temperature to the second temperature.

A resin composition including a resin and fine particles that contain an acrylic resin or a butadiene resin as a main component has higher tack strength at lower temperatures. Therefore, feeding the first resin-impregnated fiber bundle F1 from the fiber bundle feeding device at the relatively high first temperature can reduce the likelihood that the first resin-impregnated fiber bundle F1 may stick and tangle inside the fiber bundle feeding device. Further, winding the first resin-impregnated fiber bundle F1 around the mandrel 100 after cooling the first resin-impregnated fiber bundle F1 to the second temperature allows the first resin-impregnated fiber bundle F1 being wound to stick to the mandrel 100 and/or the first resin-impregnated fiber bundle F1 having been wound earlier, which can reduce the likelihood of sideslipping of the first resin-impregnated fiber bundle F1. The first temperature may be appropriately selected according to the resin and the fine particles included in the first resin-impregnated fiber bundle F1 such that the first resin-impregnated fiber bundle F1 does not tangle inside the fiber bundle feeding device. The second temperature may be appropriately selected according to the resin and the fine particles included in the first resin-impregnated fiber bundle F1 such that the first resin-impregnated fiber bundle F1 does not sideslip while being wound. For example, the first temperature may be within a range of 15° C. to 25° C. and the second temperature may be within a range of 0° C. to 15° C.

The cap 14 is mounted to an outer surface of the protruding part 22a. Then, the resin included in the winding 24 (the first resin-impregnated fiber bundle F1) is preliminary cured to solidify. The conditions for preliminary curing (the temperature, time, etc.) may be appropriately set according to the resin type. The resin may be solidified until the resin loses its fluidity.

Next, while the mandrel 100 is rotated, a cutting edge of a cutter 110 is inserted into the groove 101a of the mandrel 100 to divide the winding 24 into two. Then, as shown in FIG. 5, the divided winding 24 is removed from the mandrel 100. Thus, the first domed member 22 and the second domed member 23 are obtained. The first domed member has the protruding part 22a, with the through-hole 22b formed in the protruding part 22a. While the cutter 110 is not particularly limited, for example, a rotary disc cutter having a blade formed in an outer circumferential surface, a thin-plate cutter having a blade formed in a side surface, a laser cutter, or the like can be used.

The viscosity of the resin included in first resin-impregnated fiber bundle F1 at the time when the winding 24 is divided by the cutter 110 and when the winding 24 is removed from the mandrel 100 may be 0.05 Pa·s to 100 Pa·s. When the viscosity of the resin is not lower than 0.05 Pa·s, the likelihood that the winding 24 may deform while being divided by the cutter 110 and removed from the mandrel 100 can be sufficiently reduced. When the viscosity of the resin is not higher than 100 Pa·s, a large amount of uncured resin remains, so that when the resin is completely cured after the tubular member 21 and the first and second domed members 22, 23 are joined together in the joining step S03, the tubular member 21 and the first and second domed members 22, 23 can be bonded together with sufficient strength.

The higher the viscosity of the resin included in the winding 24 is at the time when the winding 24 is divided by the cutter 110 and removed from the mandrel 100, the less likely it is that the winding 24 may deform. The winding 24 may be divided and/or removed from the mandrel 100 after the resin included in the winding 24 is completely cured (undergoes main curing) (e.g., until the physical properties, such as the Young's modulus, become stable).

The resin included in the winding 24 may be solidified after the winding 24 is divided by the cutter 110. Solidification of the resin is not essential. When not solidifying the resin, one may apply a mold release agent to a surface of the mandrel 100, or reduce the speed of pulling the winding 24 away from the mandrel 100, to remove the winding 24 from the mandrel 100 while maintaining its shape.

It is also possible to form the winding 24 with the cap 14 mounted thereon by mounting the cap 14 in advance at a connection part between the main body 101 and the shaft 102 of the mandrel 100 and then winding the first resin-impregnated fiber bundle F1 around the outer surface of the mandrel 100 In this case, part of the cap 14 is restrained by being covered with the first resin-impregnated fiber bundle F1, so that the cap 14 is firmly fixed by the first resin-impregnated fiber bundle F1.

(ii) Tubular Member Formation Step S02

The tubular member 21 can be formed by a so-called centrifugal winding (CW) method.

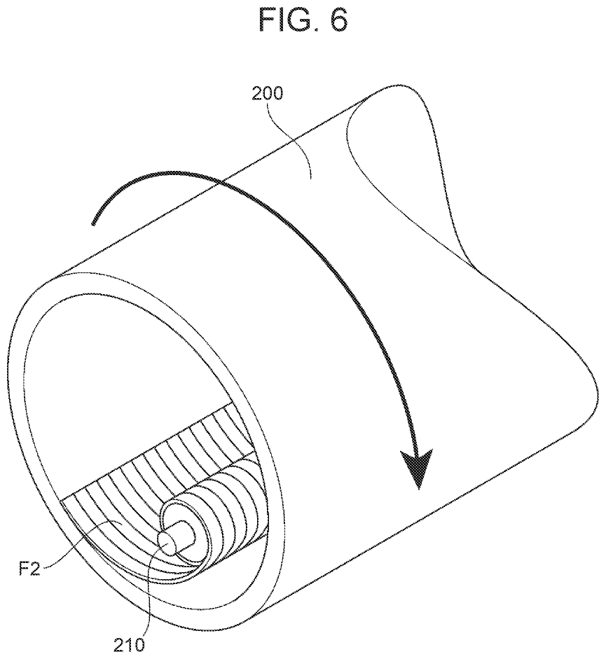

First, a fiber sheet F2 (see FIG. 6) is prepared. As the fiber sheet F2, for example, a so-called uni-direction (UD) sheet into which a plurality of fiber bundles arrayed in a single direction is woven with binding thread, or a fiber sheet into which a plurality of fiber bundles arrayed in a single direction and a plurality of fiber bundles intersecting (e.g., orthogonal to) these fiber bundles are woven can be used. The fiber sheet F2 is wound around a reel roller 210 such that the fibers included in the fiber sheet F2 extend in a circumferential direction of the reel roller 210. The fiber sheet F2 wound around the reel roller 210 in advance may be prepared.

As shown in FIG. 6, the reel roller 210 is installed inside a cylindrical mold 200. While not particularly limited, the material of the cylindrical mold 200 may be metal to secure the strength not to deform while the fiber sheet F2 is attached. While the cylindrical mold 200 is rotated at a predetermined rotation speed by a rotating mechanism (not shown), the fiber sheet F2 is reeled out from the reel roller 210 and attached to an inner surface of the cylindrical mold 200 by a centrifugal force and a frictional force. The fibers included in the attached fiber sheet F2 extend in a circumferential direction of the cylindrical mold 200. After or while the fiber sheet F2 is attached to the inner surface of the cylindrical mold 200, a resin is poured into the cylindrical mold 200 to impregnate the fiber sheet F2 with the resin. Or after the fiber sheet F2 is impregnated with a resin, the fiber sheet F2 is attached to the inner surface of the cylindrical mold 200. In this way, the tubular member 21 including fibers that extend in the circumferential direction is formed on the inner surface of the cylindrical mold 200.

While the resin with which the fiber sheet F2 is impregnated is not particularly limited, for example, a thermosetting resin can be used. As the thermosetting resin, as with the first resin-impregnated fiber bundle F1, a thermosetting resin such as a phenol resin, melamine resin, urea resin, or epoxy resin can be used, and particularly an epoxy resin may be used from the perspective of the mechanical strength etc.

As the fibers included in the fiber sheet F2, as with the first resin-impregnated fiber bundle F1, glass fibers, aramid fibers, boron fibers, carbon fibers, or the like can be used, and particularly carbon fibers can be preferably used from the viewpoint of the light weight, the mechanical strength, etc.

As necessary, a deaeration process of removing air bubbles from the tubular member 21 may be performed. For example, rotating the cylindrical mold 200 while giving the resin fluidity by heating etc. can remove air bubbles from the resin by a centrifugal force.

Next, the resin in the tubular member 21 is preliminarily cured to solidify by heating etc. The conditions for preliminary curing (the temperature, time, etc.) may be appropriately set according to the resin type. The resin may be preliminarily cured until the resin loses its fluidity. The resin may be preliminarily cured while the cylindrical mold 200 is rotated. Thus, air (air bubbles) present between the tubular member 21 and the cylindrical mold 200, inside the tubular member 21, etc. can be pushed out by a centrifugal force, so that a void is less likely to form inside the tubular member 21. Here, solidification of the resin is not essential.

Next, the tubular member 21 is removed from the cylindrical mold 200. When not solidifying the resin, one may apply a mold release agent to the inner surface of the cylindrical mold 200, or reduce the speed of pulling the tubular member 21 out of the cylindrical mold 200, to reduce the likelihood of deformation of the tubular member 21. When the cylindrical mold 200 is composed of a plurality of members and can be divided in a radial direction, one can remove the tubular member 21 from the cylindrical mold 200 while reducing the likelihood of deformation of the tubular member 21 by disassembling the cylindrical mold 200.

The viscosity of the resin included in the tubular member 21 at the time when the tubular member 21 is removed from the cylindrical mold 200 may be 0.05 Pa·s to 100 Pa·s. When the viscosity of the resin is not lower than 0.05 Pa·s, the likelihood that the tubular member 21 may deform while being removed from the cylindrical mold 200 can be sufficiently reduced. When the viscosity of the resin is not higher than 100 Pa·s, a large amount of uncured resin remains, so that when the resin is completely cured after the tubular member 21 and the first and second domed members 22, 23 are joined together in the joining step S03, the tubular member 21 and the first and second domed members 22, 23 can be bonded together with sufficient strength.

The higher the viscosity of the resin included in the tubular member 21 is at the time when the tubular member 21 is removed from the cylindrical mold 200, the less likely it is that the tubular member 21 may deform. The tubular member 21 may be removed from the cylindrical mold 200 after the resin included in the tubular member 21 is completely cured (undergoes main curing) (e.g., until the physical properties, such as the Young's modulus, become stable).

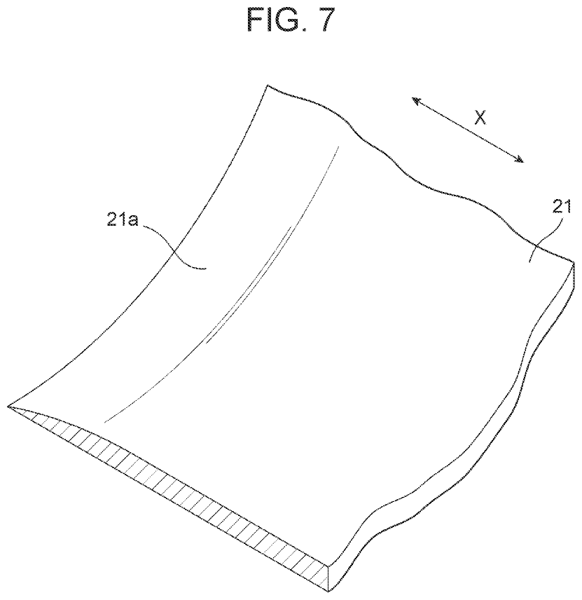

As shown in FIG. 7, in an end region 21a, in the axial direction X, of the tubular member 21, the thickness of the tubular member 21 decreases gradually toward an end. Thus, when the first reinforcing body 20 is formed by joining the first domed member 22 and the second domed member 23 to the tubular member 21 in the joining step S03, a step is less likely to be formed at the joints, so that a void is less likely to form between the first reinforcing body 20 and the second reinforcing body 13.

The tubular member 21 having such an end region 21a can be formed by, for example, using the fiber sheet F2 into which fiber bundles are woven so as to decrease gradually in the thickness near an end, in a width direction, of the fiber sheet F2. Or the end region 21a of the tubular member 21 having an even thickness may be pressed with a roller or the like to reduce the thickness.

In the example described here, the tubular member 21 is formed on the inner surface of the cylindrical mold 200. In this case, the tubular member 21 can be easily removed from the cylindrical mold 200 even when the tubular member 21 shrinks as it cures or shrinks due to temperature decrease. However, the tubular member 21 can also be formed by other methods. For example, the tubular member 21 may be formed by attaching the fiber sheet F2 to an outer surface of a cylindrical mold, or winding a fiber bundle, impregnated with a resin, around an outer surface of a cylindrical mold in hoop winding by the FW method.

(iii) Joining Step S03

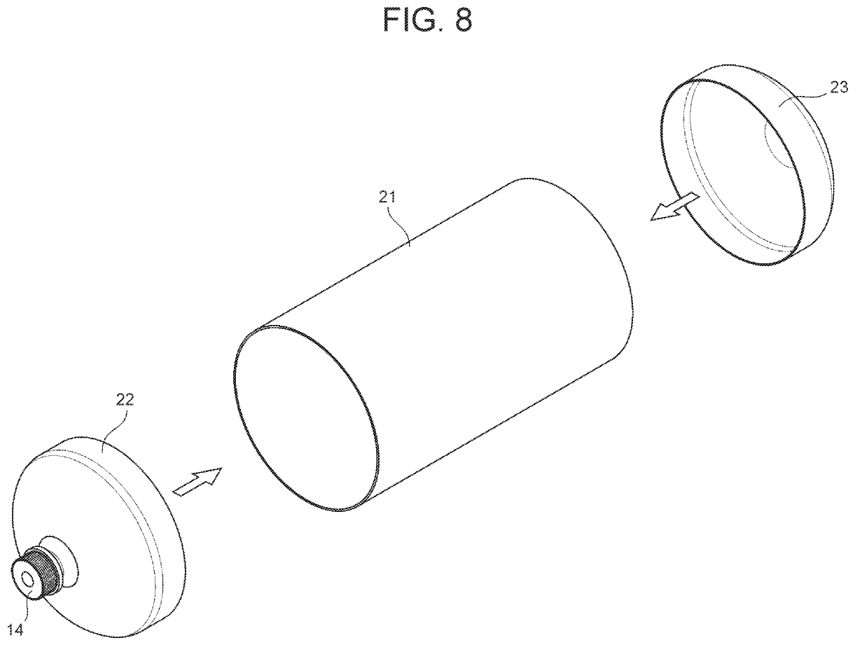

As shown in FIG. 8, the first domed member 22 and the second domed member 23 are joined to both ends of the tubular member 21. The first domed member 22 and the second domed member 23 are joined to the tubular member 21 interposed therebetween. Thus, the first reinforcing body 20 is formed.

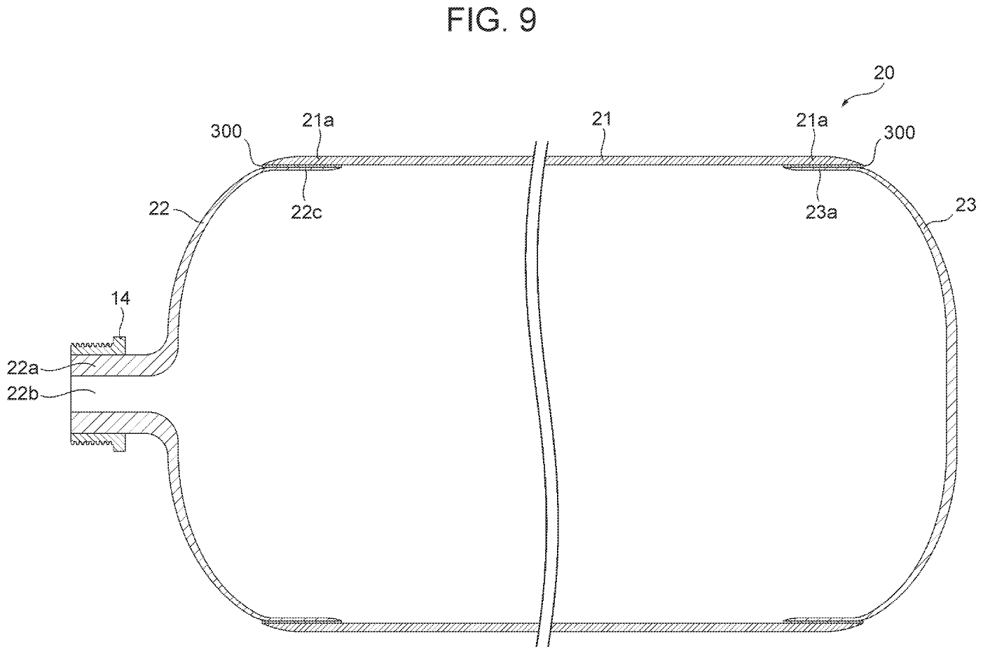

Specifically, as shown in FIG. 9, an end region 22c of the first domed member 22 is fitted and joined to one end region 21a of the tubular member 21, while an end region 23a of the second domed member 23 is fitted and joined to the other end region 21a of the tubular member 21. The first and second domed members 22, 23 may be fitted to the tubular member 21 with the end region 22c of the first domed member 22 and the end region 23a of the second domed member 23 placed on an inner side and both end regions 21a of the tubular member 21 placed on an outer side. An adhesive 300 may be disposed between the tubular member 21 and the first and second domed members 22, 23. While the material of the adhesive 300 is not particularly limited, for example, a thermosetting resin such as an epoxy resin can be preferably used. As the adhesive 300, the same resin as the resin used for the tubular member 21 and/or the first domed member 22 and the second domed member 23 may be used. Also when the adhesive 300 is not used, the resin contained in the second reinforcing body 13 formed in the second reinforcing body formation step S04 oozes from the second reinforcing body 13 while curing and thereby fills gaps between the tubular member 21 and the first and second domed members 22, 23. Therefore, the resin material forming the liner 11 is less likely to flow into the gaps between the tubular member 21 and the first and second domed members 22, 23 in the liner formation step S05.

The first domed member 22 and the second domed member 23 that are disposed on the inner side when fitted may undergo a thermal curing (preliminary curing or main curing) process in advance. This makes it easy to fit the tubular member 21 and the first and second domed members 22, 23 to each other, as the end region 22c of the first domed member 22 and the end region 23a of the second domed member 23 that have been thermally cured function as guides for the end regions 21a of the tubular member 21 in the process of fitting the tubular member 21 and the first and second domed members 22, 23 to each other. Further, the end regions 21a of the tubular member 21 may deform along the end region 22c of the first domed member 22 and the end region 23a of the second domed member 23 as guides, which allows the tubular member 21 and the first and second domed members 22, 23 to come into close contact with each other.

The strength of the first domed member 22 may be enhanced such that the first reinforcing body 20 can be reliably supported through the cap 14 mounted on the first domed member 22 in the subsequent second reinforcing body formation step S04. To enhance the strength, the first domed member 22 may be subjected to a thermal curing (preliminary curing or main curing) process.

The method for joining the tubular member 21 and the first and second domed members 22, 23 together is not limited to the above-described method. These members may be joined together, for example, through an adhesive by butting ends of the tubular member 21 and ends of the first and second domed members 22, 23 together.

(iv) Second Reinforcing Body Formation Step S04

The second reinforcing body 13 is formed on the outer surface of the first reinforcing body 20. Specifically, a support mechanism (not shown) is mounted on the cap 14 provided on the first reinforcing body 20 to hold the first reinforcing body 20. While not particularly limited, the direction of the first reinforcing body 20 being held may be such that the axial direction X of the first reinforcing body 20 is parallel or perpendicular to the direction of gravity. When the axial direction X of the first reinforcing body 20 is perpendicular to the direction of gravity, the first reinforcing body 20 can be prevented from warping due to gravity.

Second resin-impregnated fiber bundles F4 are prepared. The second resin-impregnated fiber bundle F4 includes a resin and fibers. The second resin-impregnated fiber bundle F4 can be obtained by impregnating a bundle of fibers with a resin.

While the resin is not particularly limited, for example, a thermosetting resin can be used. As the thermosetting resin, as with the first resin-impregnated fiber bundle F1, a thermosetting resin such as a phenol resin, melamine resin, urea resin, or epoxy resin can be preferably used, and especially an epoxy resin can be preferably used from the perspective of the mechanical strength etc.

As the fibers, as with the first resin-impregnated fiber bundle F1, glass fibers, aramid fibers, boron fibers, carbon fibers, or the like can be used, and especially carbon fibers can be preferably used from the viewpoint of the light weight, the mechanical strength, etc.

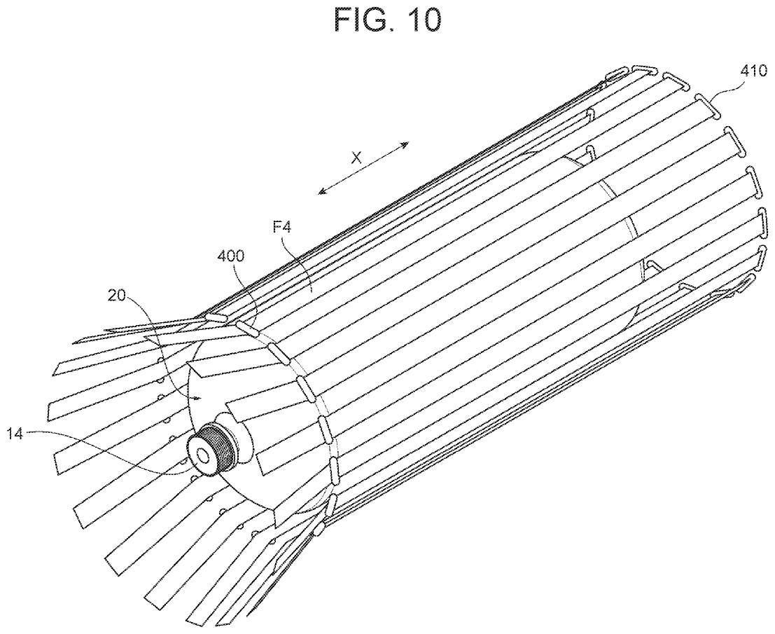

As shown in FIG. 10, a plurality of the second resin-impregnated fiber bundles F4 is disposed. The second resin-impregnated fiber bundles F4 are disposed at predetermined intervals in the circumferential direction of the first reinforcing body 20 such that each bundle extends in the axial direction X of the first reinforcing body 20 and that the bundles are separated from the outer surface of the first reinforcing body 20 by a predetermined distance. In this case, each second resin-impregnated fiber bundle F4 is reeled out through a reel 400 of a feeding reel device, and a leading end of each second resin-impregnated fiber bundle F4 is held by a holding member 410.

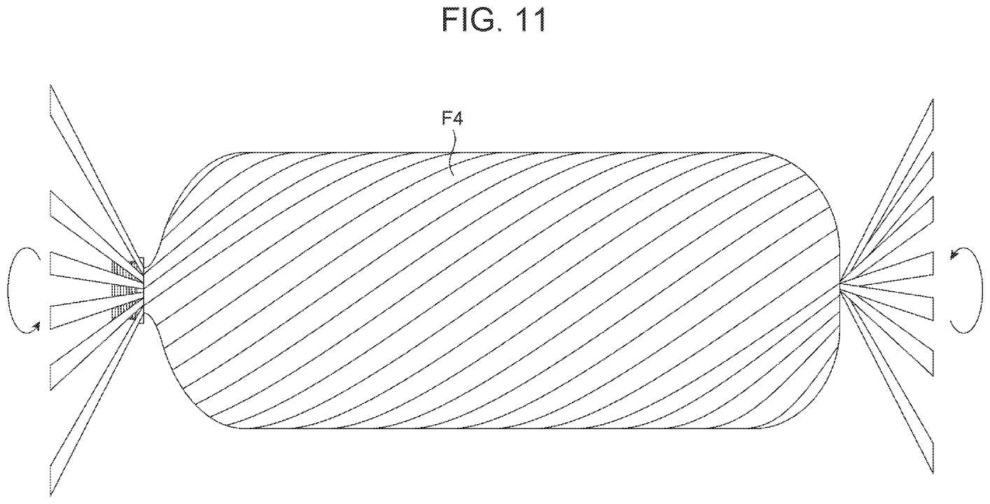

A plurality of reels 400 and a plurality of holding members 410 are rotated in opposite directions from each other along the circumferential direction of the first reinforcing body 20. Here, the reels 400 are rotated in a first direction and the holding members 410 are rotated in a second direction that is the opposite direction from the first direction. As a result, as shown in FIG. 11, the second resin-impregnated fiber bundles F4 incline relatively to the axial direction X of the first reinforcing body 20 and gaps between the second resin-impregnated fiber bundles F4 are closed, so that the second resin-impregnated fiber bundles F4 partially overlap one another and are disposed tightly on the outer surface of the first reinforcing body 20. In the state of being inclined relatively to the axial direction X, the second resin-impregnated fiber bundles F4 come into close contact with the outer surface of the first reinforcing body 20. The second resin-impregnated fiber bundles F4 are restrained from moving by the tack strength of the resin included in the second resin-impregnated fiber bundles F4. While not particularly limited, the inclination angle (the angle relative to the axial direction X of the first reinforcing body 20) of the second resin-impregnated fiber bundles F4 may be not smaller than 0 degrees nor larger than 45 degrees, and may be not smaller than 0 degrees nor larger than 20 degrees. Next, unnecessary portions of the second resin-impregnated fiber bundles F4 are cut off, and thus a first layer that covers the outer surface of the first reinforcing body 20 is formed.

Another layer that covers the first layer may be formed. For example, a second layer that covers the first layer may be formed using the second resin-impregnated fiber bundles F4. The second layer can be formed by the same method as the first layer. However, when the second layer is formed, the reels 400 may be rotated in the second direction and the holding members 410 may be rotated in the first direction. When forming a third layer and subsequent layers, odd-numbered layers may be formed in the same manner as the first layer and even-numbered layers may be formed in the same manner as the second layer.

Thus, the second reinforcing body 13 including a predetermined number of layers and covering the outer surface of the first reinforcing body 20 is formed. The number of layers is not particularly limited as long as the strength of the second reinforcing body 13 is secured; for example, the number of layers may be two to 12, and particularly two. The number of layers may be an even number. Then, a stress in the circumferential direction generated in an odd-numbered layer and that in an odd-numbered layer cancel out each other, which can reduce the likelihood that strain may occur in the high-pressure tank 10 and reduce the strength of the high-pressure tank 10.

Thereafter, the first reinforcing body 20 and the second reinforcing body 13 are cured by heating, for example, at a temperature of 100 degrees to 170 degrees for 10 minutes to 120 minutes. During the curing process, the adhesive 300 is taken into and integrated with the first reinforcing body 20 and the second reinforcing body 13.

Thus, the first reinforcing body 20 and the second reinforcing body 13 composed of a fiber-reinforced resin are formed, and the fiber-reinforced resin member 12 including the first reinforcing body 20 and the second reinforcing body 13 is obtained.

The fibers included in the second reinforcing body 13 are laid over the first domed member 22, the second domed member 23, and the tubular member 21. Thus, the second reinforcing body 13 prevents the first domed member 22 and the second domed member 23 from coming off the tubular member 21 under the pressure of the gas filling the liner 11.

In the second reinforcing body formation step S04, the second reinforcing body 13 can be formed on the outer surface of the first reinforcing body 20 without the first reinforcing body 20 being rotated in the circumferential direction. Therefore, a structure (commonly, a cap) for rotatably supporting the first reinforcing body 20 need not be provided at both ends of the first reinforcing body 20.

The second reinforcing body 13 may be formed by other methods than the above-described method. For example, the second reinforcing body 13 may be formed by a so-called sheet winding method in which a fiber sheet impregnated with a resin is wound around the outer surface of the first reinforcing body 20. The second reinforcing body 13 may be formed on the outer surface of the first reinforcing body 20 by the FW method. When using the FW method, one may cure the first reinforcing body 20 before forming the second reinforcing body 13 to prevent deformation of the first reinforcing body 20.

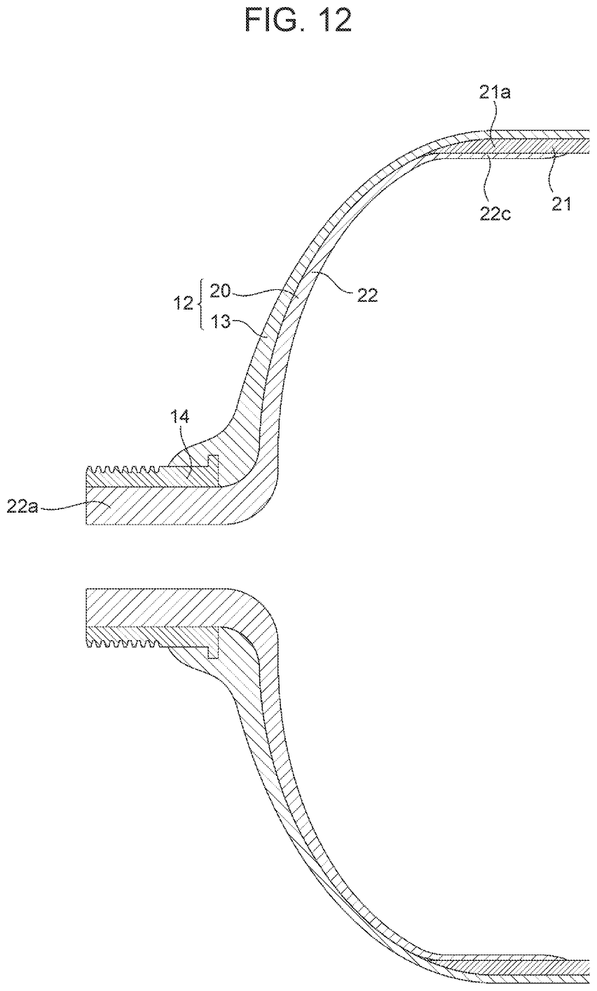

As in a first modified example shown in FIG. 12, one end of the second reinforcing body 13 may cover part of the cap 14. Thus, the cap 14 is fixed by the second reinforcing body 13, so that the cap 14 can be prevented from coming off the first reinforcing body 20.

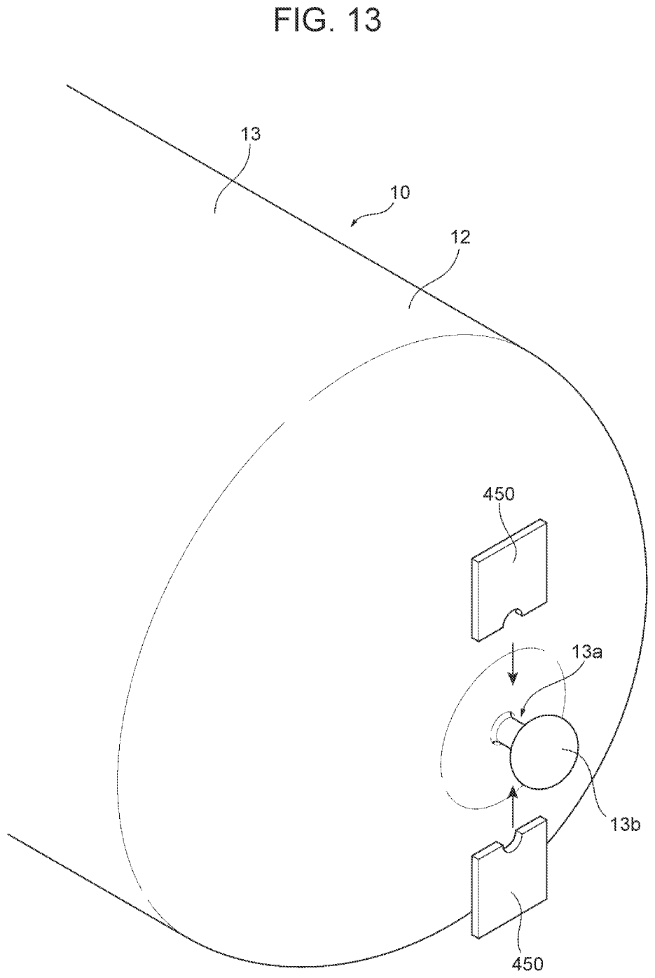

As in a second modified example shown in FIG. 13, a bulging part 13b having a recess 13a may be formed at the other end of the second reinforcing body 13. Thus, for example, the other end of the second reinforcing body 13 can be held by a holding member 450 as shown in FIG. 13, which facilitates handling of the high-pressure tank 10. The bulging part 13b having the recess 13a can be easily formed by appropriately adjusting the position of cutting the second resin-impregnated fiber bundles F4.

(v) Liner Formation Step S05

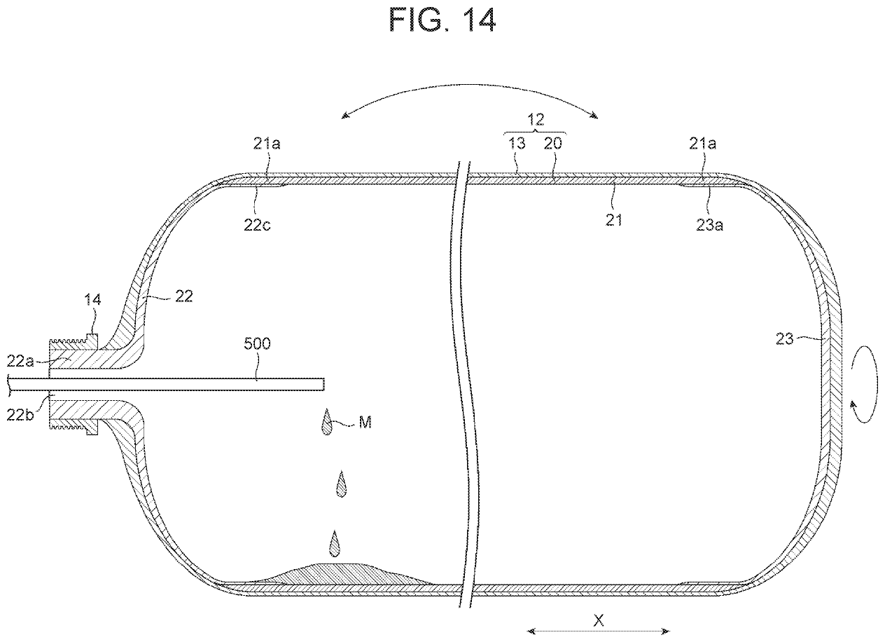

As shown in FIG. 14, the through-hole 22b formed in the protruding part 22a of the first reinforcing body 20 allows communication between an internal space of the fiber-reinforced resin member 12 and an external space. A nozzle 500 that ejects a resin material M is inserted into the internal space of the fiber-reinforced resin member 12 through the through-hole 22b, and the resin material M is supplied into the internal space of the fiber-reinforced resin member 12. Then, the nozzle 500 is pulled out of the internal space.

As described above, the resin material M is preferably a resin having high gas barrier properties. Examples of such a resin include thermoplastic resins such as polyamide, polyethylene, ethylene vinyl alcohol copolymer resin (EVOH), and polyester, and a thermosetting resin such as epoxy, among which polyamide is preferable. As the resin material M, a powder material can also be used other than a material that has fluidity at room temperature.

Next, the fiber-reinforced resin member 12 is held with the axial direction X of the fiber-reinforced resin member 12 lying perpendicular to the direction of gravity. The internal space of the fiber-reinforced resin member 12 is heated to or above a predetermined temperature as necessary. While the resin material M is kept at low viscosity (0 Pa·s to 0.05 Pa·s) and given fluidity, the fiber-reinforced resin member 12 is rotated in the circumferential direction around an axis and at the same time both ends of the fiber-reinforced resin member 12 are alternately moved up and down (see FIG. 14). As a result, the resin material M adheres to the entire inner surface of the first reinforcing body 20 and covers the entire inner surface of the first reinforcing body 20. Then, the resin material M is cured. Thus, the liner 11 is formed along the inner surface of the first reinforcing body 20.

The liner 11 may be formed by other methods than the above-described method. For example, as in blow molding, a tubular resin material having been heated and softened is pushed out into the fiber-reinforced resin member 12 through the through-hole 22b, and then compressed air is sent into the resin material. As a result, the resin material covers the inner surface of the fiber-reinforced resin member 12. In this state, the resin material is solidified. Thus, the liner 11 is formed. Or, as in thermal spraying, spraying a liquid or softened resin material onto the inner surface of the fiber-reinforced resin member 12 can also form the liner 11.

The liner formation step S05 may be performed before the second reinforcing body formation step S04.

When the valve 15 is mounted onto the cap 14, the high-pressure tank 10 is completed.

In the manufacturing method of the first embodiment, the first reinforcing body 20 is manufactured from the tubular member 21, the first domed member 22, and the second domed member 23. Each of the tubular member 21, the first domed member 22, and the second domed member 23 can be formed using an appropriate amount of fiber-reinforced resin that is sufficient to withstand the pressure of the gas filling the liner 11. Since there is no need to use an excessive amount of fiber-reinforced resin, the weight of the high-pressure tank 10 can be reduced.

Since the liner 11 is formed after the fiber-reinforced resin member 12 is formed, the manufacturing method of the first embodiment does not include a step of directly winding fiber bundles around the liner 11. When the step of directly winding fiber bundles around the liner 11 is involved, the liner 11 is required to have high strength so as not to deform under the winding fastening force. In the first embodiment, however, since fiber bundles are not directly wound around the liner 11, the liner 11 is not required to have high strength so as not to deform under the winding fastening force, and therefore the thickness (plate thickness) of the liner 11 can be reduced. As a result, the volume of the liner 11 can be increased and the weight thereof can be reduced.

Various design changes can be made to the manufacturing method of the first embodiment within the scope of the spirit of the disclosure described in the claims.

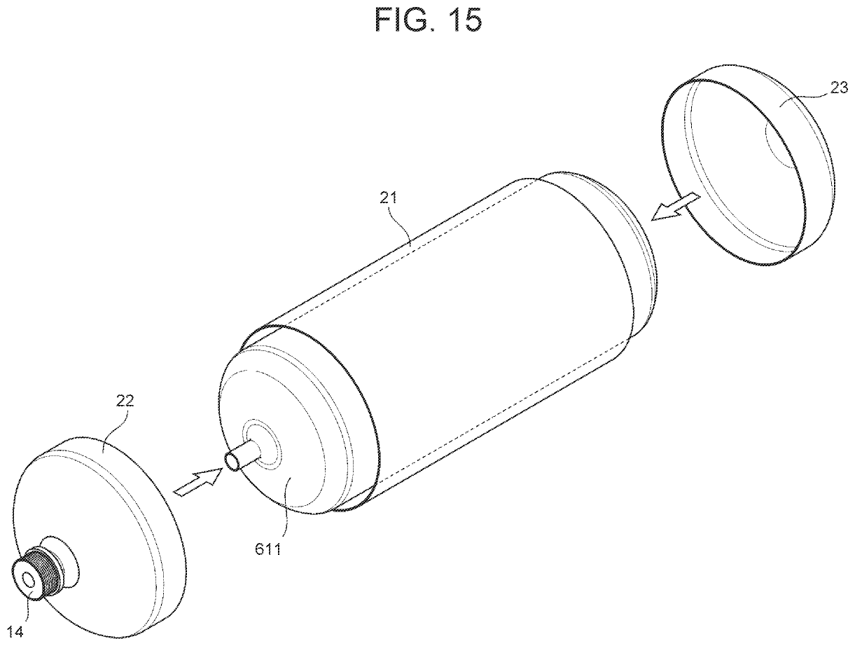

For example, in the joining step S03, as in a third modified example shown in FIG. 15, the tubular member 21, the first domed member 22, and the second domed member 23 may put over a resin liner 611 that is formed in advance, and then the tubular member 21 and the first and second domed members 22, 23 may be joined together. In this case, the liner formation step S05 is not performed. The liner 611 may be formed by an arbitrary method such as injection molding or extrusion molding. Since fiber bundles are not wound around an outer surface of the liner 611 by the FW method, the liner 611 is not required to have high strength. Therefore, the thickness of the liner 611 can be reduced, and thereby the volume of the liner 611 can be increased and the weight thereof can be reduced. The liner 611 may be formed by a metal material such as an aluminum alloy.

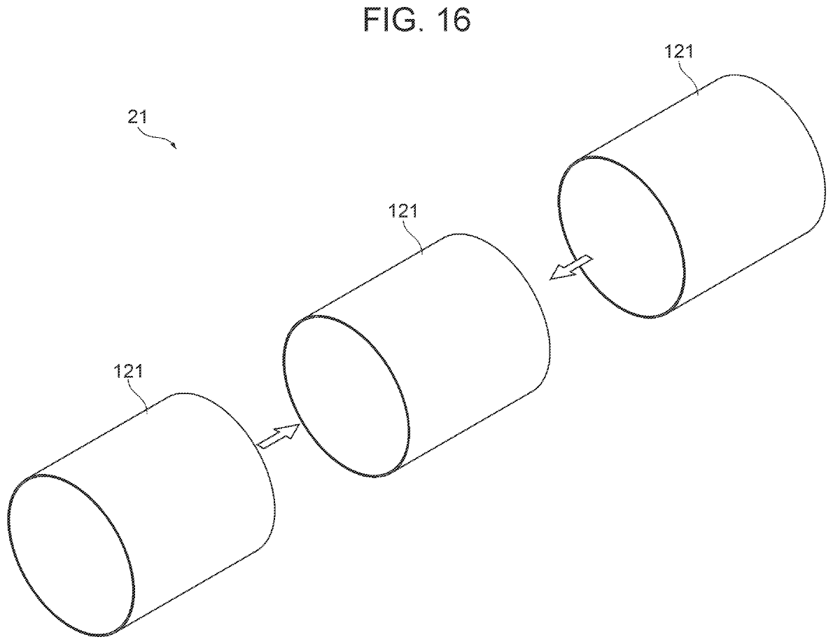

As in a fourth modified example shown in FIG. 16, the tubular member 21 may be formed by connecting two or more (in FIG. 16, three) tubular bodies 121 to one another. In this case, the two or more tubular bodies 121 may be joined together and then the first domed member 22 and the second domed member 23 may be joined to both ends of the tubular bodies 121. Or one tubular body 121 may be joined to each of the first domed member 22 and the second domed member 23 and then these members may be joined together. The tubular body 121 can be formed by the same manner as the tubular member 21. Specifically, the tubular body 121 may be composed of a fiber-reinforced resin, and fibers included in the fiber-reinforced resin may extend in a circumferential direction of the tubular body 121.

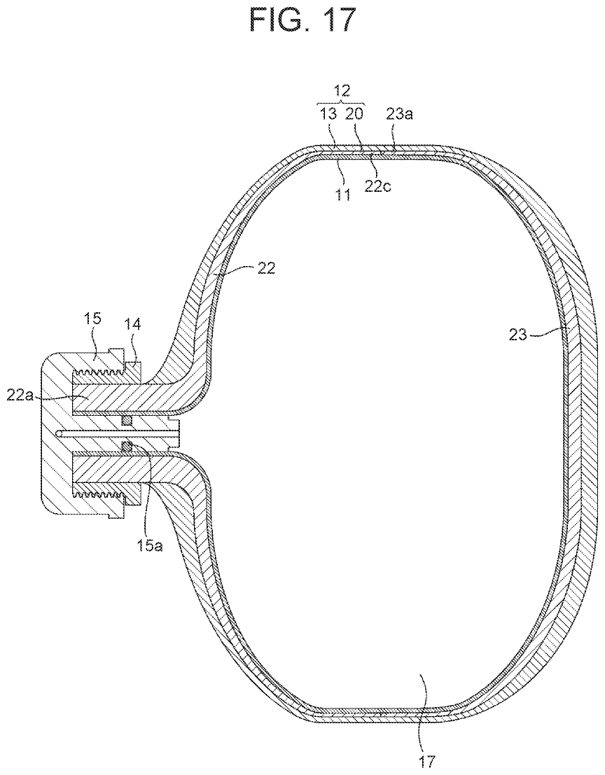

As in a fifth modified example shown in FIG. 17, the first reinforcing body 20 may include two members (e.g., the first domed member 22 and the second domed member 23) and the tubular member 21 may be omitted. In this case, the tubular member formation step S02 is not needed, and the first domed member 22 and the second domed member 23 are directly joined together in the joining step S03. In this application, “joining two domed members” means both directly joining the first domed member 22 and the second domed member 23 together and joining the first domed member 22 and the second domed member 23 to another member (e.g., the tubular member 21) interposed therebetween.

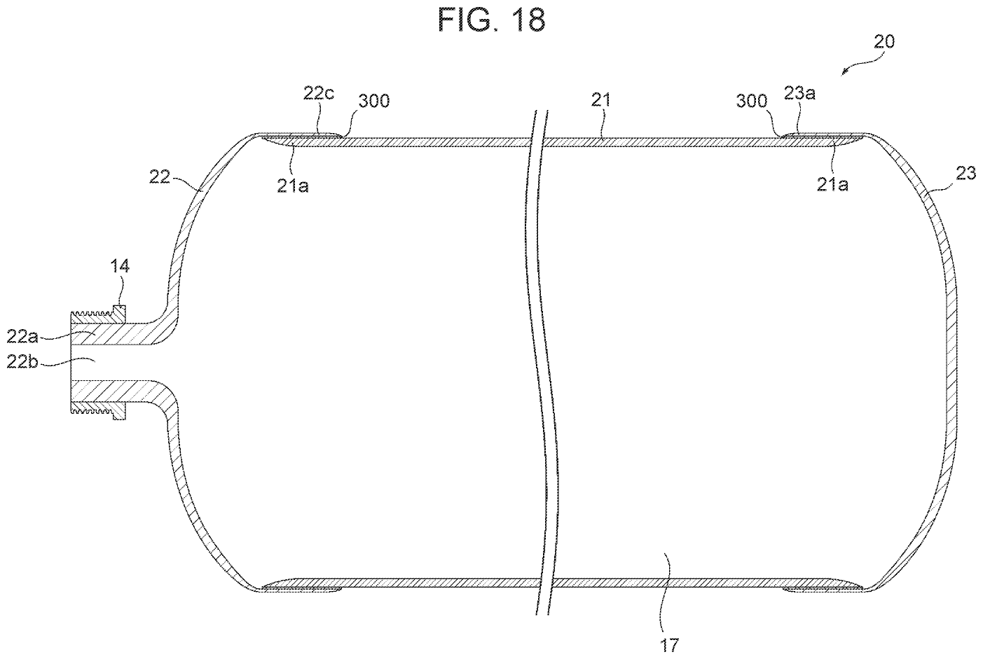

As in a sixth modified example shown in FIG. 18, in the joining step S03, after the tubular member 21 undergoes a thermal curing (preliminary curing or main curing) process, the tubular member 21 and the first and second domed members 22, 23 may be joined together with the end region 22c of the first domed member 22 and the end region 23a of the second domed member 23 placed on the outer side and both end regions 21a of the tubular member 21 placed on the inner side. In this case, it is easy to fit the tubular member 21 and the first and second domed members 22, 23 to each other, as well as to adjust outer shapes of the first domed member 22 and the second domed member 23 and bring the first domed member 22 and the second domed member 23 into close contact with the tubular member 21.

The through-hole 22b may be formed in the fiber-reinforced resin member 12 after the joining step S03. A through-hole may be provided in each of the first domed member 22 and the second domed member 23, and a cap may be provided at each of one end and the other end of the high-pressure tank 10.

### (2) Second Embodiment

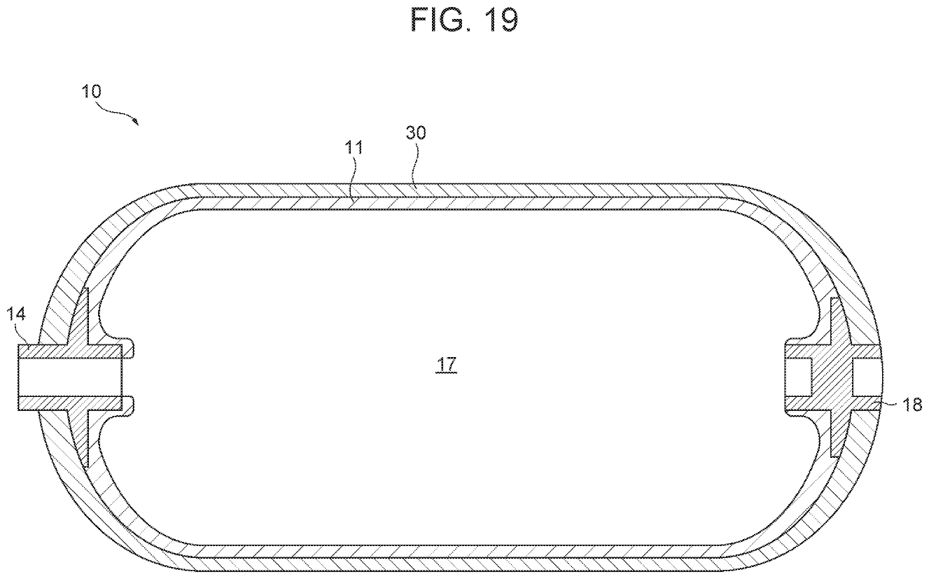

FIG. 19 is a schematic sectional view of a high-pressure tank 10 manufactured by a manufacturing method of a second embodiment. The high-pressure tank 10 includes a liner 11, a reinforcing body (first reinforcing body) 30, a first cap 14, and a second cap 18. The purpose of the high-pressure tank 10 manufactured by the manufacturing method of the second embodiment is the same as that of the high-pressure tank 10 manufactured by the manufacturing method of the first embodiment.

Since the liner 11 is made of the same material and has the same shape as the liner 11 described in the first embodiment, description thereof will be omitted. In the second embodiment, the liner 11 may be formed by a metal material such as an aluminum alloy.

The reinforcing body 30 reinforces the liner 11 by covering an outer surface of the liner 11, and thereby enhances the mechanical strength, such as the rigidity and the pressure resistance, of the high-pressure tank 10. The reinforcing body 30 includes a fiber-reinforced resin containing a resin, fibers, and fine particles that contain an acrylic resin or a butadiene resin as a main component.

Since the first cap 14 is the same as the cap 14 described in the first embodiment, description thereof will be omitted. The second cap 18 has a substantially columnar shape without a through-hole. The second cap 18 functions to conduct heat inside the high-pressure tank 10 to an outside. The material of the second cap 18 may be the same as the material of the first cap 14. The first cap 14 and the second cap 18 function also as mount parts by which the liner 11 is mounted to a filament winding device (FW device) to form the reinforcing body 30.

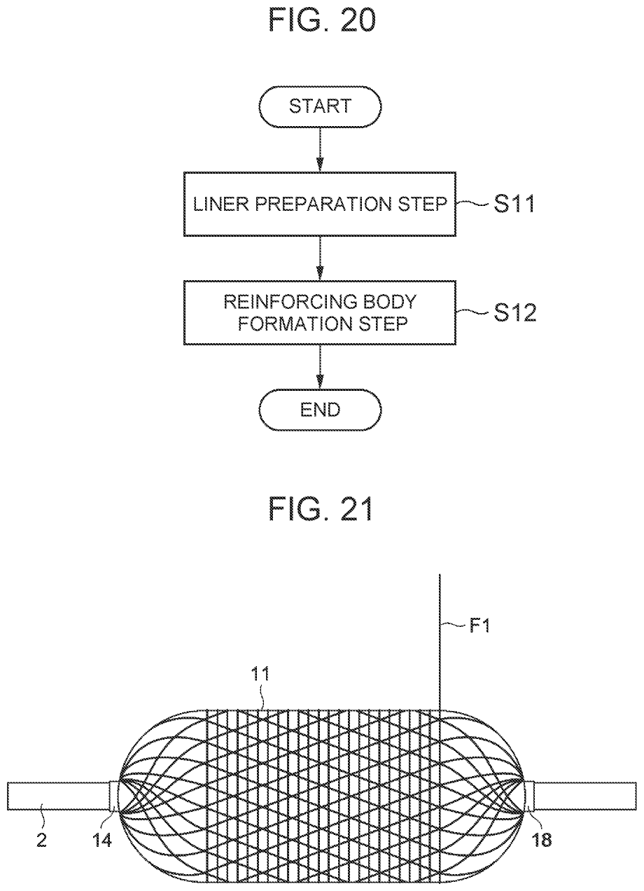

As shown in FIG. 20, the manufacturing method of the second embodiment includes a liner preparation step S11 and a reinforcing body formation step S12.

(i) Liner Preparation Step S11

The liner 11 is produced by an arbitrary method. For example, the resin liner 11 can be formed by producing resin domed members and a resin cylindrical member by injection molding, extruding molding, or the like, and welding these members together. It is not necessary to self-produce the liner 11, and a liner 11 having been molded in advance may be obtained. Next, the first cap 14 and the second cap 18 are mounted to the liner 11 by a method such as press-fitting.

(ii) Reinforcing Body Formation Step S12

A first resin-impregnated fiber bundle F1 (see FIG. 21) is prepared. Since the first resin-impregnated fiber bundle F1 is the same as the first resin-impregnated fiber bundle F1 described in the first embodiment, description thereof will be omitted.

As shown in FIG. 21, the first resin-impregnated fiber bundle F1 is wound around the liner 11 by the FW method.

Specifically, first, a shaft 2 is mounted to each of the first cap 14 and the second cap 18 of the liner 11, and the liner 11 is supported by a support structure (not shown) through the shafts 2. The support structure has a rotating mechanism (not shown). Then, the first resin-impregnated fiber bundle F1 having a first temperature is fed from a fiber bundle feeding device (not shown) toward the liner 11. The fed first resin-impregnated fiber bundle F1 is cooled to a second temperature lower than the first temperature. While the liner 11 is rotated by the rotating mechanism, the cooled first resin-impregnated fiber bundle F1 is wound around an outer surface of the liner 11 to cover the outer surface of the liner 11 with the first resin-impregnated fiber bundle F1. The first resin-impregnated fiber bundle F1 may be wound a predetermined number of times by alternately repeating hoop winding and helical winding.

The fiber bundle feeding device may be installed in a first room that is kept at the first temperature, while the liner 11 may be installed in a second room that is kept at the second temperature. Thus, the first resin-impregnated fiber bundle F1 can be wound around the liner 11 after being cooled from the first temperature to the second temperature.

A resin composition including a resin and fine particles that contain an acrylic resin or a butadiene resin as a main component has higher tack strength at lower temperatures. Therefore, feeding the first resin-impregnated fiber bundle F1 from the fiber bundle feeding device at the relatively high first temperature can reduce the likelihood that the first resin-impregnated fiber bundle F1 may stick and tangle inside the fiber bundle feeding device. Further, winding the first resin-impregnated fiber bundle F1 around the liner 11 after cooling the first resin-impregnated fiber bundle F1 to the second temperature allows the first resin-impregnated fiber bundle F1 being wound to stick to the liner 11 and/or the first resin-impregnated fiber bundle F1 having been wound earlier, which can reduce the likelihood of sideslipping of the first resin-impregnated fiber bundle F1. The first temperature may be appropriately selected according to the resin and the fine particles included in the first resin-impregnated fiber bundle F1 such that the first resin-impregnated fiber bundle F1 does not tangle inside the fiber bundle feeding device. The second temperature may be appropriately selected according to the resin and the fine particles included in the first resin-impregnated fiber bundle F1 such that the first resin-impregnated fiber bundle F1 does not sideslip while being wound. For example, the first temperature may be within a range of 15° C. to 25° C. and the second temperature may be within a range of 0° C. to 15° C.

Next, the resin included in the wound first resin-impregnated fiber bundle F1 is cured by heating etc. Thus, the reinforcing body 30 composed of a fiber-reinforced resin and covering the outer surface of the liner 11 is formed.

Another reinforcing body may be formed on an outer surface of the reinforcing body 30. For example, another reinforcing body can be formed by winding a resin-impregnated fiber bundle around the reinforcing body 30 and curing a resin included in the resin-impregnated fiber bundle.

The embodiments and modified examples described above are illustrative and not restrictive. The scope of the disclosure is defined not by the description of the above embodiments but by the claims and includes all changes equivalent in meaning and scope to the claims.

(1) Preparation of Resin Compositions

Resin compositions 1 to 3 were prepared. The constitution of each resin composition is as shown in Table 1.

TABLE 1

| | Component | Content (wt %) |
|---|---|---|
| Resin composition 1 | Bisphenol A liquid epoxy resin | 67 |
| | 1,4-butanediol glycidyl ether | 7 |
| | Diamino diphenyl methane | 24 |
| | Acrylic rubber fine particles | 2 |
| Resin composition 2 | Bisphenol A liquid epoxy resin | 67 |
| | 1,4-butanediol glycidyl ether | 7.5 |
| | Diamino diphenyl methane | 24 |
| | Butadiene rubber fine particles | 1.5 |
| Resin composition 3 | Bisphenol F liquid epoxy resin | 70 |
| | Diamino diphenyl methane | 25 |
| | Polyether sulfone (PES) | 5 |

(2) Measurement of Tack Strength

The tack strengths (tackiness) of Resin compositions 1 to 3 were measured as follows using a tacking tester (TAC-1000 manufactured by Rhesca Co., Ltd.). First, specimens were produced by applying each of Resin compositions 1 to 3 in the shape of a circle with a diameter of 10 mm. Each specimen was placed on a cooling-heating stage, and a stainless-steel columnar probe having a diameter of 5 mm was disposed above the specimen. The temperature of the cooling-heating stage was 0° C. to 60° C. The probe was moved down at a speed of 30 mm/min until it touched the specimen, and the specimen was further pressurized with a force of 100 gf. After pressurization was continued 20 seconds, the probe was lifted off the specimen at a speed of 30 mm/min. The magnitude of a force required to lift the probe until it came off the specimen was monitored, and the maximum value of the magnitude was regarded as the tack strength of the resin composition.

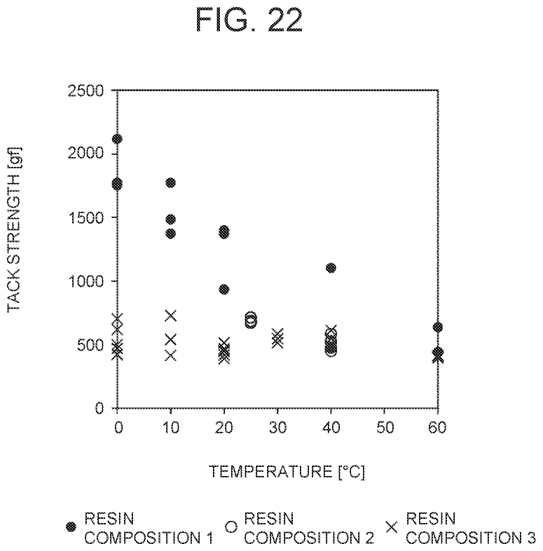

FIG. 22 is a graph in which the tack strengths of Resin compositions 1 to 3 relative to the temperature of the stage are plotted. The tack strengths of Resin compositions 1 and 2 are higher at lower temperatures. The tack strength of Resin composition 3 is substantially constant regardless of the temperature.

(3) Winding Test

Resin-impregnated fiber bundle 1 was prepared by impregnating carbon fibers with Resin composition 1. Similarly, Resin-impregnated fiber bundles 2 and 3 were prepared from Resin compositions 2 and 3, respectively. Resin-impregnated fiber bundles 1 to 3 were reeled out from an FW device installed in a room at room temperature. All of Resin-impregnated fiber bundles 1 to 3 were reeled out without tangling inside the FW device.

Resin-impregnated fiber bundles 1 to 3 reeled out from the FW device were fed to a room kept at 10° C. or lower and then wound around a mandrel having a dome-shaped part and placed in that room. It was observed whether Resin-impregnated fiber bundles 1 to 3 thus wound would sideslip. Resin-impregnated fiber bundles 1 and 2 did not sideslip but Resin-impregnated fiber bundle 3 sideslipped.

What is claimed is:

1. A manufacturing method of a high-pressure tank including a liner that houses gas and a first reinforcing body that covers an outer surface of the liner, the manufacturing method comprising a step of forming the first reinforcing body involving cooling a first resin-impregnated fiber bundle fed from a fiber bundle feeding device and having a first temperature to a second temperature lower than the first temperature and winding the cooled first resin-impregnated fiber bundle around a mandrel or the liner, wherein the first resin-impregnated fiber bundle includes fine particles that contain an acrylic resin or a butadiene resin as a main component.

2. The manufacturing method according to claim 1, wherein:
the step of forming the first reinforcing body includes
a step of forming two domed members, and
a step of joining the two domed members together to form the first reinforcing body; and
the step of forming the two domed members involves
cooling the first resin-impregnated fiber bundle fed from the fiber bundle feeding device and having the first temperature to the second temperature lower than the first temperature and winding the cooled first resin-impregnated fiber bundle around the mandrel to form a winding, and
dividing the winding to form the two domed members.

3. The manufacturing method according to claim 2, further comprising a step of covering an inner surface of the first reinforcing body with a resin to form the liner.

4. The manufacturing method according to claim 2, further comprising a step of forming a second reinforcing body on an outer surface of the first reinforcing body.

5. The manufacturing method according to claim 2, wherein:
the step of forming the first reinforcing body further includes a step of forming a tubular member; and
the two domed members are joined to the tubular member interposed between the domed members.

6. The manufacturing method according to claim 5, wherein the tubular member includes fibers that extend in a circumferential direction of the tubular member.
